(19) United States
(12) Patent Application Publication
(10) Pub. No.: US 2017/0325502 A1
(43) Pub. Date: Nov. 16, 2017

(54) CONNECTOR ASSEMBLY AND METHOD

(71) Applicant: Altria Client Services LLC, Richmond, VA (US)

(72) Inventors: Greg NELSON, Richmond, VA (US); Bipin PATIL, Richmond, VA (US); Rangaraj SUNDAR, Richmond, VA (US); Jimmy CROW, Richmond, VA (US); Clark CRUMP, Richmond, VA (US)

(21) Appl. No.: 15/154,439

(22) Filed: May 13, 2016

(51) Int. Cl. A24F 47/00; H05B 3/00; B21D 22/24

(52) U.S. Cl. CPC A24F 47/008; B21D 22/24; H05B 3/0014

(57) ABSTRACT

A method of forming a post of a cartridge of an electronic vaping device includes cutting a blank from a sheet of metal, drawing the blank to a desired diameter and length to form an elongate body, reverse drawing a portion of the elongate body to form a first end having an opening therein, the first end being generally cylindrical and having a generally beveled edge at an edge thereof, forming a bulged portion between the first end and a second end of the elongate body, and forming a flared section at the second end.

### BACKGROUND

### Field

The present disclosure relates to a connector assembly of an electronic vaping or e-vaping device and methods of forming the connector assembly.

### Description of Related Art

Electronic vaping devices may include a power supply section and a cartridge. The power supply section and the cartridge may be connected by a connector, such as a threaded connector.

### SUMMARY

At least one example embodiment relates to a method of forming a post of a cartridge of an electronic vaping device.

In at least one example embodiment, the method includes cutting a blank from a sheet of metal, drawing the blank to a desired diameter and length to form an elongate body, drawing a portion of the elongate body to form a first end having an opening therein, the first end being generally cylindrical and having an edge, forming a first portion between the first end and a second end of the elongate body, and forming a second portion at the second end.

In at least one example embodiment, the method may include trimming a portion of the second portion to form the post.

In at least one example embodiment, the method may include deburring the post.

In at least one example embodiment, the method may include cleaning the post.

In at least one example embodiment, the method may include passivating the post. The passivating operation may include treating the post with at least one of nitric acid and citric acid. The treating may include placing the post in a solution containing at least one of nitric acid and citric acid for about 1 minute to about 60 minutes at a temperature ranging from about 50° F. to about 200° F. The treating may also include removing the post from the solution, and rinsing the post with water until the water has a pH of about 6 to about 8.

In at least one example embodiment, the blank may be formed of stainless steel. The post blank may have a diameter ranging from about 0.500 inch to about 0.700 inch. For example, the post blank may have a diameter of about 0.610 inch. The post blank may have a thickness ranging from about 0.010 inch to about 0.040 inch. For example, the post blank may have a thickness of about 0.015 inch. The connector blank may have a diameter ranging from about 0.750 inch to about 1.000 inch. For example, the connector blank may have a diameter of about 0.900 inch. The connector blank may have a thickness ranging from about 0.010 inch to about 0.060 inch. For example, the connector blank may have a thickness of about 0.033 inch.

At least one example embodiment relates to a method of forming a connector piece of a cartridge of an electronic vaping device.

In at least one example embodiment, the method may include forming a metal blank from a sheet of metal, drawing the metal blank to a desired depth and diameter to form a connector piece body, punching a hole in a first end of the connector piece body, and forming a threaded portion on an inner surface of a second end of the connector piece body to form the connector piece.

In at least one example embodiment, the method may include deburring the connector piece.

In at least one example embodiment, the method may include cleaning the connector piece.

In at least one example embodiment, the forming a threaded portion may include using a tap to form the threaded portion.

In at least one example embodiment, the forming a threaded portion may include thread rolling to form the threaded portion.

At least one example embodiment relates to a cartridge of an electronic vaping device.

In at least one example embodiment, a cartridge of an electronic vaping device comprises an outer housing extending in a longitudinal direction, an inner tube extending in the longitudinal direction within the outer housing, a reservoir between the outer housing and the inner tube, a heating element in the inner tube, a first connector piece in the second end of the outer housing, a gasket extending through a portion of the orifice in the first connector piece, and a post extending through the second orifice in the gasket. The outer housing has a first end and a second end. The gasket includes a second orifice extending in the longitudinal direction through the gasket. The first connector piece is generally cylindrical. The first connector piece includes an orifice extending through the first connector piece. The orifice extends in the longitudinal direction. The post includes a first post end and a second post end. The first post end is sized and configured to fit within the inner tube. The first post end is in direct contact with an inner wall of the inner tube.

In at least one example embodiment, the heating element includes opposing end portions extending into the reservoir. The cartridge also includes a first electrical lead and a second electrical lead. The first and second electrical leads are connected to the opposing end portions of the heating element. The first electrical lead may be attached to the first connector piece and the second electrical lead may be attached to the post.

In at least one example embodiment, the post includes an air flow passage extending therethrough. The air flow passage establishes an air flow channel between the connector and the inner tube. The air flow passage may have an inner diameter ranging from about 1.50 mm to about 4.00 mm. For example, the air flow passage may have an inner diameter ranging from about 1.50 mm to about 1.70 mm.

In at least one example embodiment, the post includes a bulged portion between a first end and a second end thereof. The bulged portion is sized and configured to maintain the post within the second orifice of the gasket. In at least one example embodiment, the post may include a portion at the second end thereof. The portion may be configured to contact an inner surface of the first connector piece. The first end of the post may have about a same diameter as an outer diameter of the portion of the post.

In at least one example embodiment, the first connector piece and the post are formed of stainless steel.

In at least one example embodiment, an outer diameter of the first post end is about the same as an inner diameter of the inner tube.

In at least one example embodiment, the first end of the post has a larger diameter than a central portion of the post.

In at least one example embodiment, the first end of the post is generally cylindrical and includes a beveled edge at the first end.

### BRIEF DESCRIPTION OF THE DRAWINGS

The various features and advantages of the non-limiting embodiments herein may b ore apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 is a side view of an electronic vaping device including a connector according to at least one example embodiment.

FIG. 2 is a cross-sectional view along line II-II of the electronic vaping device and the connector of FIG. 1 according to at least one example embodiment.

FIG. 3 is an exploded view of a cartridge of an electronic vaping device including a first connector assembly according to at least one example embodiment.

FIG. 4 is a bottom, perspective view of a connector piece according to at least one example embodiment.

FIG. 5 is a side top view of a connector piece according to at least one example embodiment.

FIG. 6 is a cross-sectional view along line VI-VI according to at least one example embodiment.

FIG. 7 is a perspective view of a post of a connector assembly of an electronic vaping device according to at least one example embodiment.

FIG. 8 is a side view of a post of a connector assembly of an electronic vaping device according to at least one example embodiment.

FIG. 9 is a cross-sectional view along line IX-IX of a post of a connector assembly of an electronic vaping device according to at least one example embodiment.

FIGS. 10A, 10B, and 10C are cross-sectional view of a post of a connector assembly of an electronic vaping device according to at least one example embodiment.

FIGS. 11A, 11B, 11C, and 11D are cross-sectional views of a connector of an electronic vaping device according to at least one example embodiment.

FIG. 12 is a floe chart illustrating a method of making a post of an electronic vaping device according to least one example embodiment.

FIG. 13 is a flow chart illustrating a cleaning step of a method of making a post according to at least one example embodiment.

FIG. 14 is a flow chart illustrating a method of making a connector according to at least one example embodiment.

FIG. 15 is a cross-sectional view along line II-II of a cartridge according to at least one example embodiment.

FIG. 16 is a cross-sectional view of a post according to at least one example embodiment.

FIG. 17 is a perspective view of the post of FIG. 16 according at least one example embodiment.

### DETAILED DESCRIPTION OF EXAMPLE EMBODIMENTS

Some detailed example embodiments are disclosed herein. However, specific structural and functional details disclosed herein are merely representative for purposes of describing example embodiments. Example embodiments may, however, be embodied in many alternate forms and should not be construed as limited to only the example embodiments set forth herein.

Accordingly, while example embodiments are capable of various modifications and alternative forms, example embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, components, regions, layers and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various example embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

At least one example embodiment relates to an electronic vaping device including a connector.

FIG. 1 is a side view of an electronic vaping device including a connector according to at least one example embodiment.

In at least one example embodiment, as shown in FIG. 1, an electronic vaping device 60 may include a first section (or cartridge) 70 and a second section (or battery section) 72, which may be coupled together at a connector 74. The connector 74 may include a first connector assembly associated with the first section 70 and a second connector assembly associated with the second section. At least some portions of the first and/or second connector assemblies may be formed by a deep drawn process as described below. At least portions of the first and/or second connector assemblies may be formed of stainless steel so as to reduce and/or prevent chemical reactions with a pre-vapor formulation.

In at least one example embodiment, the first section 70 may include an outer housing 22′ extending in a longitudinal direction. The second section 72 may also include an outer housing 22 extending in the longitudinal direction.

In at least one example embodiment, the outer housing 22, 22′ may have a generally cylindrical cross-section. In other example embodiments, the outer housing 22, 22′ may have a generally triangular cross-section along one or more of the first section 70 and the second section 72. In some example embodiments, the outer housing 22, 22′ may have a greater circumference or dimensions at a second end 10 than at a first end 4 of the electronic vaping device 60.

In at least one example embodiment the second section 72 and first section 70 may be connected using a threaded, bayonet, cam-lock and/or snap-fit connector. For example, the bayonet connector is described in U.S. Patent Application Publication No. 2014/0261493 to Smith et al. filed Mar. 11, 2014, the entire contents of which is incorporated herein by reference thereto.

In at least one example embodiment, a mouth-end insert 180 may be received in the outer housing 22′ at the first end 4.

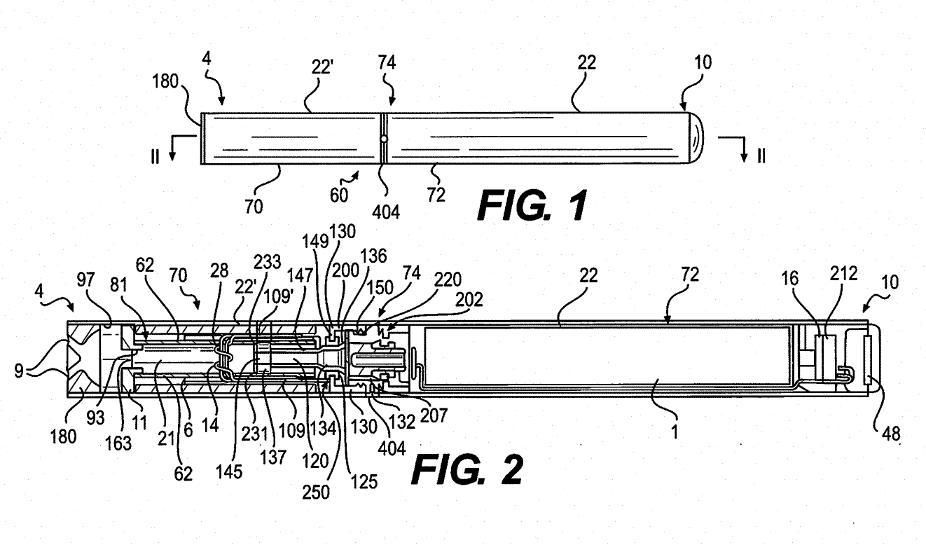

FIG. 2 is a cross-sectional view along line II-II of the electronic vaping device and connector of FIG. 1 according to at least one example embodiment.

In at least one example embodiment, as shown in FIG. 2, the connector 74 may include a first connector assembly 200 and a second connector assembly 202. The first connector assembly 200 is arranged in the first section 70 and the second connector assembly 202 is arranged in the second section 72. The first connector assemble 200 is connectable to the second connector assembly 202 to join the first section 70 with the second section 72.

In at least one example embodiment, the first connector assembly 200 includes a connector body 130, a gasket 125, and a post 120. The post 120 and/or the connector body 130 may be formed of stainless steel.

In at least one example embodiment, the post 120 may include a first post end 231 and a second post end 132. The post 120 may be generally cylindrical in cross-section. An outer diameter of the post 120 may vary along a length thereof. The post 120 may include a sidewall 147 that defines a flow passage 145 extending longitudinally through the post 120. The first post end 231 includes a nose portion 137 that is sized and configured to be received in the inner tube 62. The nose portion 137 fits snugly in an inner tube 62 that is coaxially positioned within the outer housing 22′. The fit between the nose portion 137 and the inner tube 62 is such that there is no need for additional sleeves or other materials to hold the nose portion 137 in place within the inner tube 62. Since no additional materials are needed to hold the nose portion 137 in place within the inner tube 62, manufacture may be automated and/or more easily facilitated due to the need for fewer parts. In other example embodiments, an adhesive may be used to ensure a tight fit between the nose portion 127 and the inner tube 62.

In at least one example embodiment, when the nose portion 137 of the post 120 is inserted in the inner tube 62, the flow passage 145 is in fluid communication with a central air passage 21 defined by the inner tube 62.

In at least one example embodiment, the post 120 has an inner diameter ranging from about 1.40 mm to about 4.00 mm (e.g., about 1.45 mm to about 1.75 mm or about 1.50 mm to about 1.70 mm). For example, the inner diameter may be about 1.60 mm, and the inner diameter may aid in establishing a desired resistance-to-draw (RTD) ranging from about 60 mm H₂O to about 130 mm H₂O. The inner diameter of the post 120 may be altered to adjust the RTD of the electronic vaping device 60.

In at least on example embodiment, the post 120 extends through an opening in a gasket 125. The gasket 125 is arranged in an opening in the connector body 130. Thus, the post 120 extends through the opening in the gasket 125 and the opening in the connector body 130. The opening in the gasket 125 is sized and configured to snugly fit around a portion of the post 120, and an outer diameter of the gasket 125 is sized and configured to fit snugly within the opening in the connector body 130.

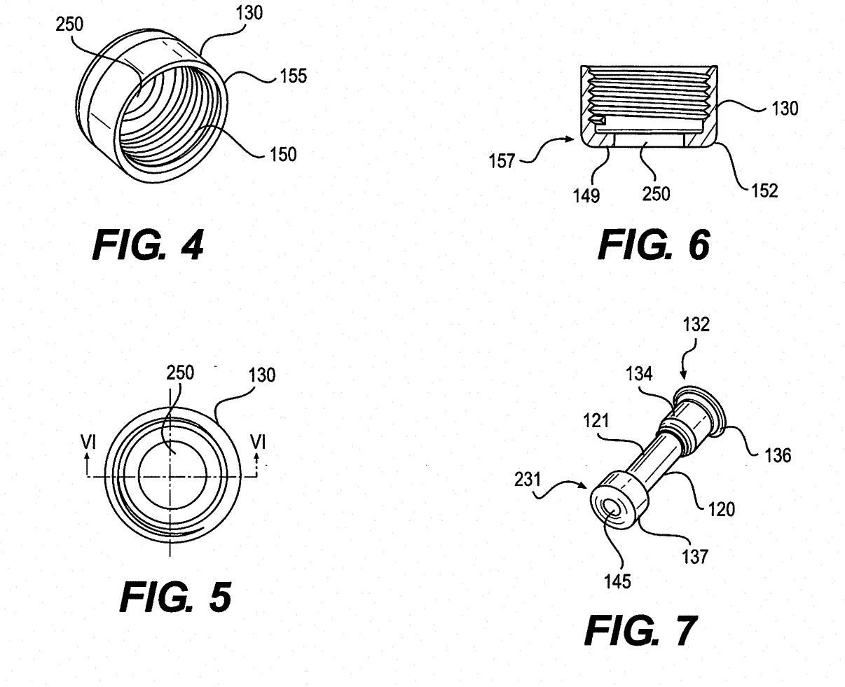

In at least one example embodiment, the gasket 125, along with the post 120, may at least partially seal an opening 250 (shown in FIGS. 4, 5, and 6) in the connector body 130 so as to reduce leakage of the pre-vapor formulation from the first section70 through the first connector assembly 200. The gasket 125 may be generally cylindrical and may be formed of silicon, rubber, or a suitable plastic material.

In at least one example embodiment, the connector body 130 is generally cylindrical and includes the opening 250 extending longitudinally therethrough. A neck portion 149 may surround the opening 250. The connector body 130 also includes a threaded section 150 opposite the opening 250. The threaded section 150 is configured to effect connection between the first section 70 and the second section 72. The threaded section 150 may be a male or female threaded section. As shown, the threaded section 150 is a female threaded section 150 that is configured to receive a male threaded section of the second connector assembly 202.

In at least one example embodiment, the second connector assembly 202 may be arranged in the second section 72. The second connector assembly may include a second threaded portion 220 in a second connector body 207. The second threaded portion 220 may be a male or female threaded section. At least one air inlet 404 may extend through a sidewall portion of the second connector body 207. The air inlet 404 may be in fluid communication with the flow passage 145 of the post 120 when the first connector assembly 200 is mated with the second connector assembly 202 as shown in FIG. 2.

It should be appreciated that more than two air inlets 440 may be included in the second connector assembly 202. Alternatively, an air inlet may be included in the outer housing 22, 22′.

In at least one example embodiment, a reservoir 6 may be established between the outer housing 22′ and the inner tube 62 of the first section 70. The reservoir 6 may be configured to contain a pre-vapor formulation.

In at least one example embodiment, the pre-vapor formulation may be a material or combination of materials that may be transformed into a vapor. For example, the pre-vapor formulation may be a liquid, solid and/or gel formulation including, but not limited to, water, beads, solvents, active ingredients, ethanol, plant extracts, natural or artificial flavors, tobacco material, and/or vapor formers such as glycerin and propylene glycol. The pre-vapor formulation may include those described in U.S. Patent Application Publication No. 2015/0020823 to Lipowicz et al. filed Jul. 16, 2014 and U.S. Patent Application Publication No. 2015/0313275 to Anderson et al. filed Jan. 21, 2015, the entire contents of each of which is incorporated herein by reference thereto.

In at least one example embodiment, the reservoir 6 may at least partially surround the central inner passage 21 in the inner tube 62. A heater 14 may extend transversely across the inner passage 21 between opposing portions of the reservoir 6. In some example embodiments, the heater 14 may extend parallel to a longitudinal axis of the inner passage 21.

In at least one example embodiment, the reservoir 6 may be sized and configured to hold enough pre-vapor formulation such that the electronic vaping device 60 may be configured for wiping for at least about 200 seconds.

In at least one example embodiment, as shown in FIG. 2, the first section 70 may also include a heater 14 that may vaporize the pre-vapor formulation, which may be drawn from the reservoir 6 by a wick 28. The electronic vaping device 60 may include features set forth in U.S. Patent Application Publication No. 2013/0192623 to Tucker et al. filed Jan. 31, 2013, the entire content of which is incorporated herein by reference thereto.

In at least one example embodiment, the air inlet 440 may aid in providing a substantially consistent RTD. The air inlet 440 may be sized and configured such that the electronic vaping device 60 has a RTD in the range of from about 60 mm H₂O to about 150 mm H₂O. For example, the air inlet 440 may have a diameter of about 0.50 to about 0.70 mm or about 0.62 mm.

In at least one example embodiment, a gasket 11 may be fitted into a first end portion 81 of the inner tube 62 so as to reduce leakage from the reservoir. The gasket 11 may include a nose portion 93 that may be fitted into the first end portion 81 of the inner tube 62. An outer perimeter of the gasket 11 may provide a substantially liquid-tight seal with an interior surface 97 of the outer housing 22′. The gasket 11 may include a central channel 163 disposed between the inner passage 21 of the inner tube 62 and a mouth-end insert 180, which may transport the vapor from the inner passage 21 to the mouth-end insert 180.

During vaping, pre-vapor formulation may be transferred from the reservoir 6 to the proximity of the heater 14 by the wick 28. The wick 28 may include a first end portion and a second end portion, which may extend into opposite sides of the reservoir 6. The heater 14 may at least partially surround a central portion of the wick 28 such that when the heater 14 is activated, the pre-vapor formulation in the central portion of the wick 28 may be vaporized by the heater 14 to form a vapor.

In at least one example embodiment, the wick 28 may include filaments (or threads) having a capacity to draw the pre-vapor formulation. For example, the wick 28 may be a bundle of glass (or ceramic) filaments, a bundle including a group of windings of glass filaments, etc., all of which arrangements may be capable of drawing pre-vapor formulation via capillary action by interstitial spacings between the filaments. The filaments may be generally aligned in a direction perpendicular (transverse) to the longitudinal direction of the electronic vaping device 60. In at least one example embodiment, the wick 28 may include one to eight filament strands, each strand comprising a plurality of glass filaments twisted together. The end portions of the wick 28 may be flexible and foldable into the confines of the reservoir 6. The filaments may have a cross-section that is generally cross-shaped, clover-shaped, Y-shaped, or in any other suitable shape.

In at least one example embodiment, the wick 28 may include any suitable material or combination of materials. Examples of suitable materials may be, but not limited to, glass, ceramic- or graphite-based materials. The wick 28 may have any suitable capillarity drawing action to accommodate pre-vapor formulations having different physical properties such as density, viscosity, surface tension and vapor pressure.

In at least one example embodiment, the heater 14 may include a wire coil which at least partially surrounds the wick 28. The wire may be a metal wire and/or the heater coil may extend fully or partially along the length of the wick 28. The heater coil may further extend fully or partially around the circumference of the wick 28. In some example embodiments, the heater coil 14 may or may not be in contact with the wick 28.

The heater coil may be formed of any suitable electrically resistive materials. Examples of suitable electrically resistive materials may include, but not limited to, titanium, zirconium, tantalum and metals from the platinum group. Examples of suitable metal alloys include, but not limited to, stainless steel, nickel, cobalt, chromium, aluminum-titanium-zirconium, hafnium, niobium, molybdenum, tantalum, tungsten, tin, gallium, manganese and iron-containing alloys, and super-alloys based on nickel, iron, cobalt, stainless steel. For example, the heater 14 may be formed of nickel aluminide, a material with a layer of alumina on the surface, iron aluminide and other composite materials, the electrically resistive material may optionally be embedded in, encapsulated or coated with an insulating material or vice-versa, depending on the kinetics of energy transfer and the external physicochemical properties required. The heater 14 may include at least one material selected from the group consisting of stainless steel, copper, copper alloys, nickel-chromium alloys, super alloys and combinations thereof. In an example embodiment, the heater 14 may be formed of nickel-chromium alloys or iron-chromium alloys. In another example embodiment, the heater 14 may be a ceramic heater having an electrically resistive layer on an outside surface thereof.

In at least one example embodiment, the heater 14 may heat pre-vapor formulation in the wick 28 by thermal conduction. Alternatively, heat from the heater 14 may be conducted to the pre-vapor formulation by means of a heat conductive element or the heater 14 may transfer heat to the incoming ambient air that is drawn through the electronic vaping device 60 during vaping, which in turn heats the pre-vapor formulation by convection.

In at least one example embodiment, as shown in PIG. 2, electrical leads 109, 109′ may extend from the heater 14 and through the reservoir 6. One of the electrical leads 109, 109′ may be welded or otherwise attached to the post 120, and another one of the electrical leads 109, 109′ may be welded, crimped, or otherwise attached to the connector body 130. The electrical leads 109, 109′ may be welded to ends of the heater 14 or attached to ends of the heater 14 by crimping. Thus, when the first connector assembly 200 is connected with the second connector assembly 202 of the second section 72, an electrical connection may be formed between a power supply 1 in the second section 72 and the heater 14 in the first section 70.

In at least one example embodiment, the electrical leads 109, 109′ may be formed of copper or stainless steel. Stainless steel may be used to reduce reactions with the pre-vapor formulation when the electrical leads 109, 109′ pass through the reservoir 6 or are otherwise in contact with the pre-vapor formulation.

It should be appreciated that, instead of using a wick 28, the heater 14 may be a porous material which incorporates a resistance heater formed of a material having a high electrical resistance capable of generating heat quickly.

In at least one example embodiment, the second section 72 may include a power supply 1, a control circuit 212, and a sensor 16 configured to sense negative pressure and/or air being drawn into the electronic vaping device 60.

In at least one example embodiment, the power supply 1 may include the battery arranged in the electronic vaping device 60. The power supply may be a Lithium-ion battery or one of its variants, for example a Lithium-ion polymer battery. Alternatively, the power supply 1 may be a nickel-metal hydride battery, a nickel cadmium battery, a lithium-manganese battery, a lithium-cobalt battery or a fuel cell. The electronic vaping device 60 may be vaped by an adult vaper until the energy in the power supply 1 is depleted or in the case of lithium polymer battery, a minimum voltage cut-off level is achieved.

In at least one example embodiment, the power supply 1 may be rechargeable and may include circuitry configured to allow the battery to be chargeable by an external charging device. To recharge the electronic vaping device 60, an USB charger or other suitable charger assembly may be used.

In at least one example embodiment, the sensor 16 may be configured to sense an air pressure drop and initiate application of voltage from the power supply 1 to the heater 14. The control circuit 212 may also include a heater activation light 48 configured to glow when the heater 14 is activated. The heater activation light 48 may include a light-emitting diode (LED), and may be at the second end 10 of the electronic vaping device 60. Moreover, the heater activation light 48 may be arranged to be visible to an adult vaper during vaping. In addition, the heater activation light 48 may be utilized for electronic vaping system diagnostics or to indicate that recharging is in progress. The heater activation light 48 may also be configured such that the adult vaper may activate and/or deactivate the heater activation light 48 for privacy.

In at least one example embodiment, the control circuit 212 may supply power to the heater 14 responsive to the sensor 16. In one example embodiment, the control circuit 212 may include a maximum, time-period limiter. In another example embodiment, the control circuit 212 may include a manually operable switch for an adult vapor to initiate vaping. The time-period of the electric current supply to the heater 14 may be pre-set depending on the amount of pre-vapor formulation desired to be vaporized. In yet another example embodiment, the circuitry may supply power to the heater 14 as long as the sensor 16 detects a pressure drop.

When activated, the heater 14 may heat a portion of the wick 28 surrounded by the heater for less than about 10 seconds or less than about 7 second (e.g. less than about 5 seconds). Thus, the power cycle (or maximum puff length) may range in period from about 2 seconds to about 10 seconds (e.g., about 3 seconds to about 9 seconds, about 4 seconds to about 8 seconds or about 5 seconds to about 7 seconds).

In at least one example embodiment, as shown in FIG. 2, the mouth-end insert 180 can be positioned at a first end 4 of the first section 70. The mouth-end insert 180 may include at least two outlets 9, which may be located off-axis from the longitudinal axis of the electronic vaping device 60. The outlets 9 may be angled outwardly in relation to the longitudinal axis of the electronic vaping device 60. The outlets 9 may be substantially uniformly distributed about the perimeter of the mouth-end insert 180.

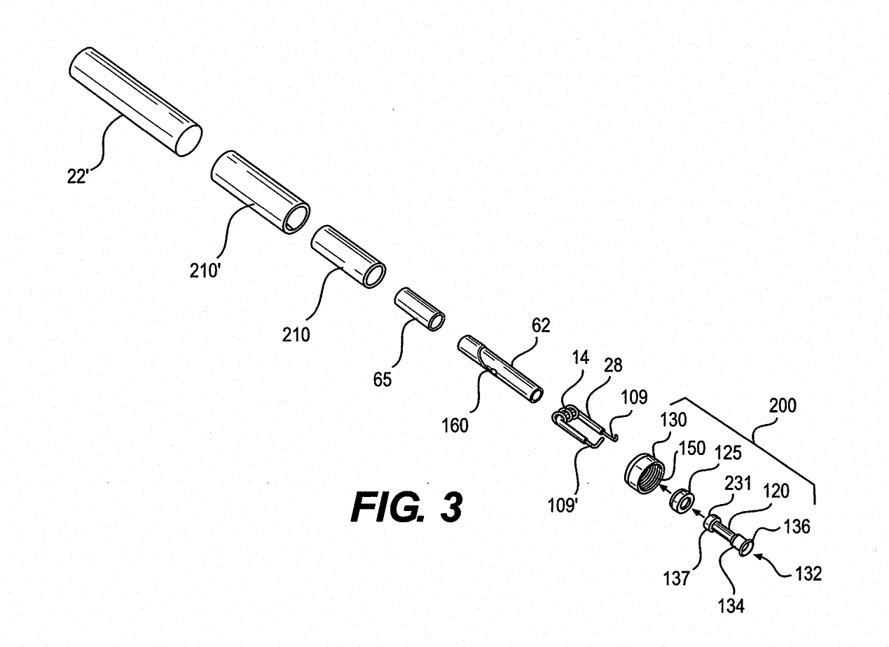

FIG. 3 is an exploded view of a cartridge of an electronic vaping device according to at least one example embodiment.

In at least one example embodiment, as shown in FIG. 3, the first section 70 is the same as in FIG. 2, but shows opposing slots 160 in the inner tube 62 (through which electrical leads 109, 109′ extend from the heater 14) and a storage medium 210, 210′. In addition, a closure ring 65 may slide over the inner tube 62 so to at least partially close the opposing slots 160 once the heater 14 and wick 28 are positioned in the opposing slots 160.

In at least one example embodiment, the opposing slots 160 in the inner tube 62 may facilitate placement of the heater 14 and wick 28 into position within the inner tube 62 without impacting edges of the slots and the coiled section of the heater 14. Accordingly, edges of the slots may not be allowed to impact and alter the coil spacing of the heater 14, which would otherwise create potential sources of hotspots along the heater 14.

In an example embodiment, the inner tube 62 may have a diameter of about 4 mm and each of the opposing slots may have major and minor dimensions of about 2 mm by about 4 mm.

In at least one example embodiment, as shown in FIG. 3, a storage medium 210, 210′ may be in the reservoir 6 between the outer housing 22′ and the inner tube 62 and may be configured to store the pre-vapor formulation therein. The storage medium 210, 210′ may include a winding of cotton gauze or other fibrous material about the inner tube 62.

In at least one example embodiment, the use of storage medium 210, 210′ negates a need for a gasket between the reservoir 6 and the first connector assembly 200. Gaskets may be formed of silicon or other materials, which may leach flavor from pre-vapor formulations. Thus, the removal of a second gasket from an electronic vaping device 60 aids in maintaining flavor and/or shelf-life of the pre-vapor formulation stored in the reservoir 6.

In at least one example embodiment, the storage medium 210, 210′ may be any porous and/or fibrous material that may hold the pre-vapor formulation therein. The storage medium 210, 210′ may be a fibrous material including at least one of cotton, polyethylene, polyester, rayon and combinations thereof. The fibers may have a diameter ranging in size from about 6 microns to about 15 microns (e.g., about 8 microns to about 12 microns or about 9 microns to about 11 microns). The storage medium 210, 210′may be a sintered, porous or foamed material. Also, the fibers may be sized to be irrespirable and may have a cross-section which has a Y-shape, cross shape, clover shape or any other suitable shape.

In at least one example embodiment, the storage medium 210, 210′ holds the pre-vapor formulation within the reservoir 6 so as to substantially negate a need for a gasket between the reservoir 6 and the connector body 130 of the connector assembly.

FIG. 4 is a bottom, perspective view of a connector piece according to at least one example embodiment.

FIG. 5 is a side top view of a connector piece according to at least one example embodiment.

FIG. 6 is a cross-sectional view along line VI-VI according to at least one example embodiment.

In at least one example embodiment, as shown in FIGS. 4, 5, and 6, the connector body 130 may be generally cylindrical. The connector body 130 may have an orifice 250 extending longitudinally therethrough. An inner surface of the connector body 130 may include a threaded portion 150. The threaded portion 150 may extend completely to a second end 155 of the connector body 130 to facilitate a connection with the second connector assembly 202 of the second section 72.

In at least one example embodiment an outer diameter of the connector body 130 has a diameter that is about the same as or less than about an inner diameter of the outer housing 22′ so that the connector body 130 fits snugly within the outer housing 22′. The connector body 130 may be held by friction fit in the outer housing 22′. In other example embodiment, the connector body 130 may be held within the outer housing 22′ by an adhesive.

In at least one example embodiment, as shown in FIG. 6, a first end 157 of the connector body 130 may include a beveled or rounded edge 152 so as to facilitate insertion of the connector body 130 into the housing 22′ during manufacture.

FIG. 7 is a perspective view of a post of a connector assembly of an electronic vaping device according to at least one example embodiment.

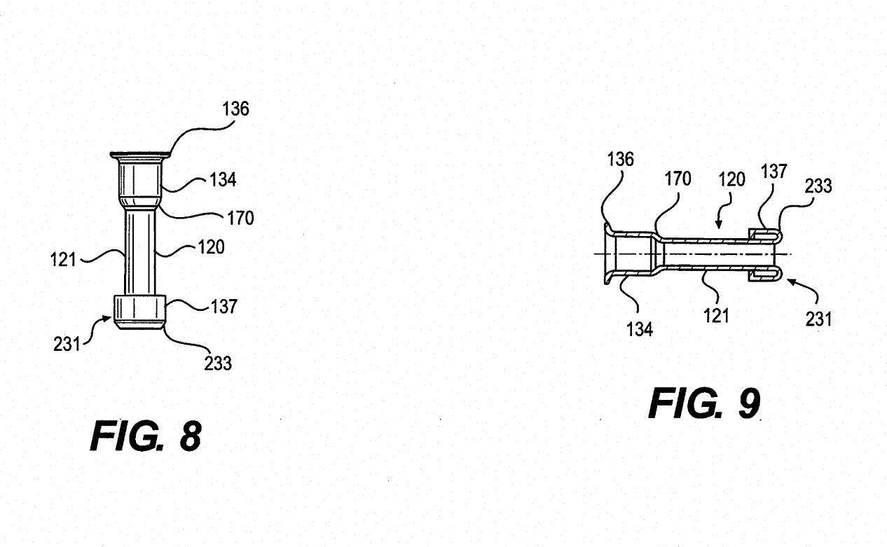

FIG. 8 is a side view of a post of a connector assembly of an electronic vaping device according to at least one example embodiment.

FIG. 9 is a cross-sectional view along line IX-IX of a post of a connector assembly of an electronic vaping device according to at least one example embodiment.

In at least one example embodiment, as shown in FIGS. 7, 8, and 9, the post 120 is the same as that of FIG. 2. However, FIGS. 7, 8, and 9 show additional details of the post 120. As shown, the post 120 may include the nose portion 137 that is sized and configured to fit snugly within the inner tube 62. The nose portion 137 may be generally cylindrical and may have a larger outer diameter than a central portion 121 of the post 120. The nose portion 137 may be formed by a draw operation of a deep drawn process as described. below. An outer diameter of the nose portion 137 may range from about 3.5 mm to about 4.0 mm. For example, the nose portion 137 may have an outer diameter of about 3.8 mm.

In at least one example embodiment, the post 120 may include a bulged portion 134 between the central portion 121 and the second end 132 of the post 120. The bulged portion 134 may be sized and configured to fit snugly within the gasket 125, and may be formed during an expand and wide operation of a deep drawn process as described below. The post may also include a flared portion 136 at the second end 132. The flared portion 136 is sized and configured to substantially prevent the post 120 from passing through the gasket 125 and to provide a contact point between the post 120 and the connector body 130 once the post 120 is positioned within the gasket 125 and connector body 130.

In at least one example embodiment, the outer diameter of the nose portion 137 is about the same as an outer diameter of the flared portion 136.

In at least one example embodiment, the post is about 13.0 mm to about 13.5 mm in length. The length may be adjusted to fit between the connector body 130 and the location of the inner tube 62 in the electronic vaping device 60. The nose portion 137 may be about 2.0 mm to about 3.0 mm (e.g., about 2.5 mm to about 2.75 mm) in length. The length of the nose portion 137 may be sufficient to establish a reliable fit within the inner tube 62. The central portion may be about 7.0 mm and about 8.0 mm. The bulged portion 135 may have a length ranging from about 2.0 mm to about 3.0 mm. For example, the bulged portion 135 may have a length of about 2.5 mm. The flared portion 136 may have a length ranging from about 0.50 mm to about 1.0 mm or about 0.75 mm.

As shown in FIGS. 8 and 9, the post 120 may include a first beveled edge 233 along the nose portion 137, and a second beveled edge 170 along the bulged portion 134. The first and second beveled edges 233, 170 facilitate insertion of the post 120 through the gasket 125 and into the inner tube 62 during manufacture, and may facilitate automated manufacture of the first section 70.

As shown in FIG. 9, the inner diameter of the post 120 is consistent along the nose portion 137 and the central portion 121. The inner diameter is larger within the bulged portion 134 and the flared portion 136.

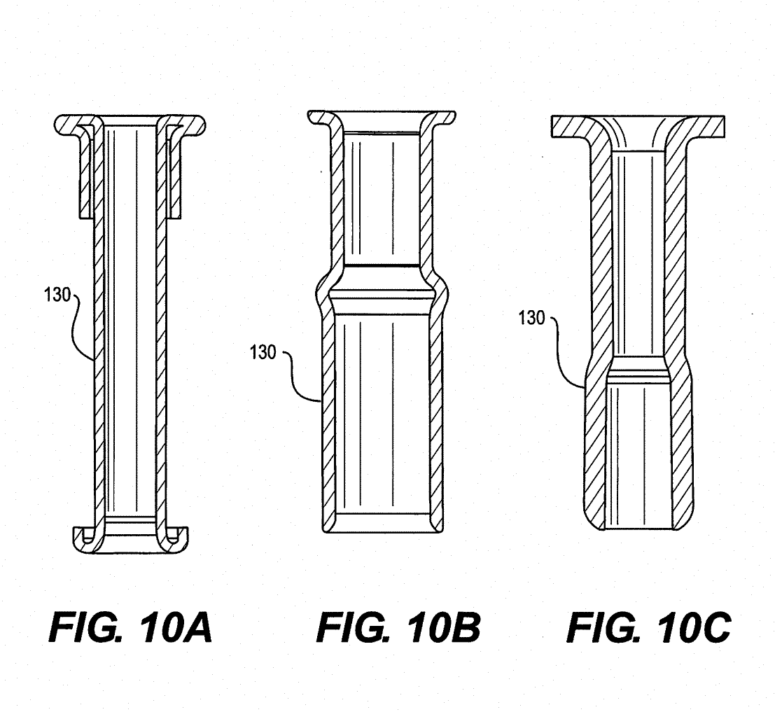

FIGS. 10A, 10B, and 10C are cross-sectional view of a post of a connector assembly of an electronic vaping device according to at least one example embodiment.

In at least one example embodiment, the post 120 may have other geometries than that shown in FIGS. 2, 7, 8, and 9, but may be formed to include a surface at the first end 231 that fits snugly within the inner tube 62 without the need for sleeves or other materials to hold the post 120 in place.

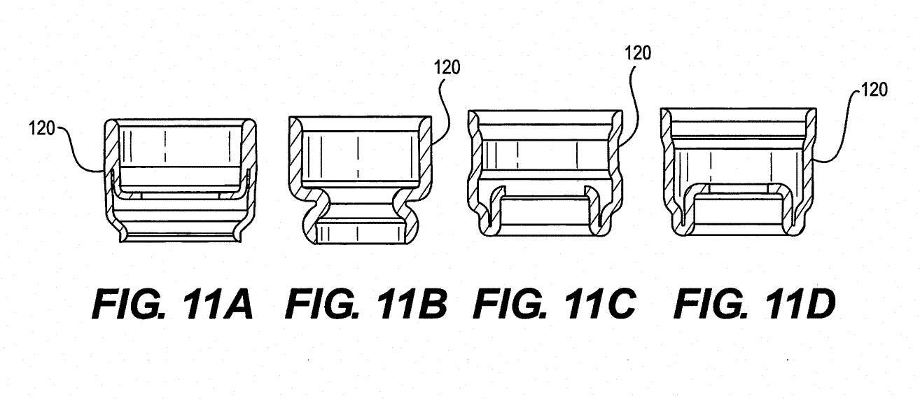

FIGS. 11A, 1113, 11C, and 11D are cross-sectional views of a connector of an electronic vaping device according to at least one example embodiment.

In at least one example embodiment, the connector body 130 may have any suitable geometry other than that shown in FIGS. 4-6 so long as the connector body 130 includes an outer surface that snugly fits within the outer housing 22′ and an inner surface that may contact a portion of the post 120 and/or aid in holding the post 120 within the connector body 130.

In at least one example embodiment, the connector body 130 and the post 120 are formed of stainless steel. Suitable grades of stainless steel include 304, 304 L, 304 deep draw quality (DDQ), 305, 316, and 316L, which provide acceptable drawing capability and corrosion resistance. In at least one example embodiment, stainless steel grade 304 L may be used to form the connector body 130 and post 120. Because the pre-vapor formulation may include acids and/or other materials that may react with metals,the use of stainless steel may aid in preventing any undesired chemical reactions.

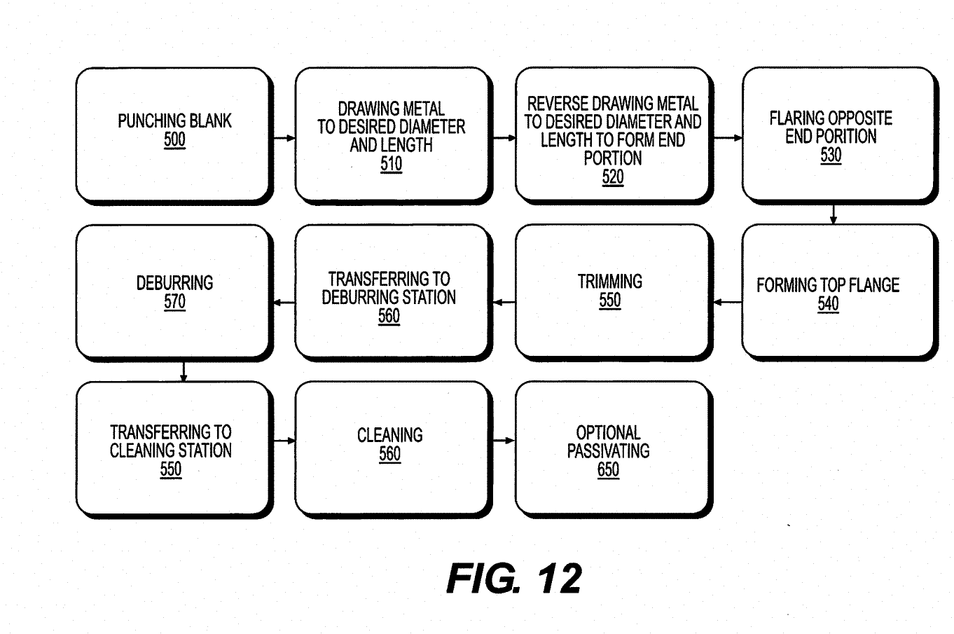

FIG. 12 is a flow chart illustrating a method of making a post of an electronic vaping device by a deep drawn process according to least one example embodiment.

In at least one example embodiment, a method of forming a connector body of a cartridge of an electronic vaping device includes forming a metal blank 500. The forming a metal blank 500 may include punching and/or cutting a generally round disc from a sheet of metal. The sheet of metal may be formed of stainless steel. The post blank (disc) may have a diameter ranging from about 0.500 inch to about 0.700 inch. In at least one example embodiment, the post blank may have a diameter of about 0.610 inch. The post blank may have a thickness ranging from about 0.010 inch to about 0.040 inch. In at least one example embodiment, the post blank has a thickness of about 0.015 inch. The connector blank (disc) may have a diameter ranging from about 0.750 inch to about 1.000 inch. In at least one example embodiment, the connector blank may have a diameter of about 0.900 inch. The connector blank may have a thickness ranging from about 0.010 inch to about 0.060 inch. In at least one example embodiment, the connector blank may have a thickness of about 0.033 inch.

In at least one example embodiment, once the metal blank 500 is formed, the method includes drawing 510 the metal blank to a desired depth and diameter to form a connector piece body. The drawing 510 includes forming the metal disc around a series of punches until a desired shape and/or length is obtained. Once a desired shape and/or length is obtained, the method may include drawing 520 at least a portion of the metal to form the nose portion 137 (shown in FIGS. 2, 3, 7, 8, and 9) at one end thereof. The method may also include forming a bulged portion 530 at a second end, and forming a flared portion 540 at the second end by an expand and wide operation. Once the desired length and/or shape has been achieved, the method may also include trimming 550 a portion of the metal around the flare portion 540 so that the flared portion has a desired diameter and a connector post is formed.

In at least one example embodiment, once the post is formed, the post may be transferred 560 to a deburring station. At the deburring station, a deburring operation 570 may be performed so as to remove any sharp edges. The deburring operation 570 may include electropolishing or any other suitable deburring operation.

In at least one example embodiment, once the post has been through the deburring operation or instead of the deburring operation, the post may be transferred 550 to a cleaning station and cleaned 560 to remove any oil and/or debris. Optionally, the method may include a passivation operation 650 to improve corrosion resistance of the post.

In at least one example embodiment, the passivation operation 650 may include a nitric acid treatment according to ASTM A 967 as set forth in Table 1 below.

TABLE 1

| Solution | Time | Temperature |
|---|---|---|
| 20-25% nitric acid and | about 20 minutes | 120° F. to 130° F. |
| 2.5% sodium dichromate | | |
| 20-40% nitric acid | about 30 minutes | 70° F. to 90° F. |
| 20-25% nitric acid | about 20 minutes | 120° F. to 140° F. |
| 45-55% nitric acid | about 30 minutes | 120° F. to 130° F. |

In at least one example embodiment, the passivation operation 650 may include a citric acid treatment according to ASTM A967 as set forth in Table 2 below.

TABLE 2

| Solution | Time | Temperature |
|---|---|---|
| 4-10% citric acid | about 4 minutes | 140° F. to 160° F. |
| 4-10% citric acid | about 10 minutes | 120° F. to 140° F. |
| 4-1% citric acid | about 20 minutes | 70° F. to 120° F. |

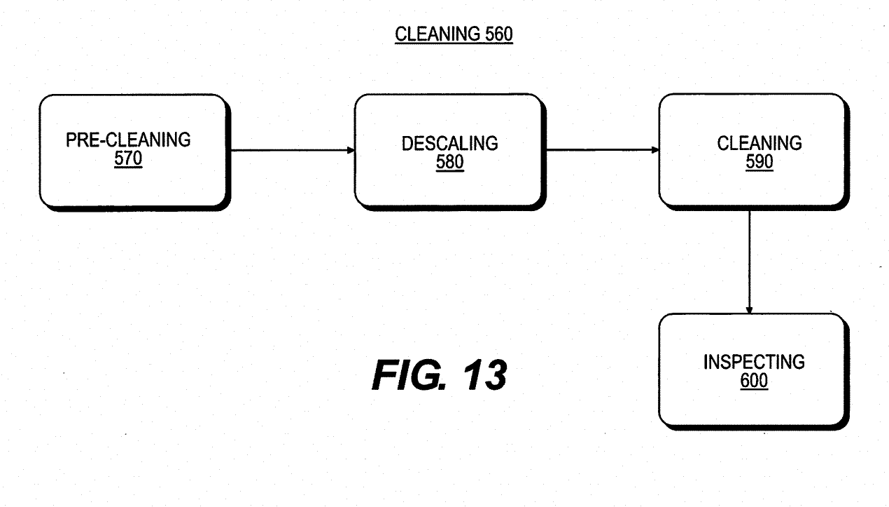

FIG. 13 is a flow chart illustrating a cleaning step of a method of making a post according to at least one example embodiment.

In at least one example embodiment, the cleaning operation 560 may include a pre-cleaning operation 570, which may include cleaning the post with a solution and/or scrubbing the post. The pre-cleaning may be done so that any passivation operations are uniformly applied to the post. The pre-cleaning operation 570 may include any suitable cleaning process including an alkaline process, an emulsion process, a vapor degreasing process, an ultrasonic process, a detergent process, a chelate solution process, a mechanical process including one or more of abrasive blast, grinding, and/or wire brushing, a steam process, and/or a water jet process.

In at least one example embodiment, the cleaning operation 560 may include acid pickling and/or a mechanical descaling process. The cleaning operation 560 may also include acid cleaning to remove iron, light oxide films, and/or dirt from the post. Once the cleaning operation 560 is complete, the post may be inspected 600.

In at least one example embodiment, is a descaling operation 58-and/or pickling process is performed, the process may be that described in ASTM A 380 Table A1, Part 1 titled “Acid Descaling.” Before pickling, the surface must be pre-cleaned. Then, the descaling solution for an annealed austenitic stainless steel may be applied. The descaling solution may include about 8% to about 11% sulfuric acid. The descaling solution may be applied for about 5 minutes to about 45 minutes at a temperature of about 150° F. to about 180° F. Alternatively, the descaling solution may include about 15 to about 25% nitric acid and about 1 to about 8% hydrofluoric acid. This descaling solution may be applied to the post for about 5 minutes to about 30 minutes at a temperature ranging from about 70° F. to about 140° F. After the descaling and/or pickling process, the post may be brushed with hot water and/or a high-pressure water jet until the wash water has a pH ranging from about 6 to about 8. Surfaces of the post should then be inspected to ensure proper cleaning.

In at least one example embodiment, if the post is formed of annealed 300 series stainless steel, the cleaning operation 560 may include acid cleaning, and the post may be cleaned with a nitric-hydrofluoric acid according to ASTM A 380 Table A2, Part I: Cleaning with Nitric-hydrofluoric acid. The cleaning solution may include a solution including 6 to 25% nitric acid and 0.5 to 8% hydrofluoric acid. The cleaning may be done at a temperature ranging from about 70° F. to about 140° F. The acid cleaning may be done for as long as necessary to clean the post.

In another example embodiment, the cleaning operation 560 of a post formed of an annealed, cold rolled, thermally hardened, or work hardened 300 series stainless steel may include acid cleaning according to ASTM A 380 Table A2.1 Part II: Cleaning-passivation with Nitric Acid, which includes cleaning and passivation with nitric acid. A solution of 20% to 30% nitric acid is applied to the post at a temperature of about 120° F. to about 160° F. for about 10 minutes to about 30 minutes. If a surface of the post is shiny, the process may include applying a solution of about 20% to about 40% nitric acid and about 2% to about 6% sodium dichromate to the post at a temperature of about 120° F. to about 160° F. for about 10 minutes to about 30 minutes.

In another example embodiment, if the post is formed of 200 or 300 series stainless steel, the cleaning operation 560 may include acid cleaning according to ASTM A 380 Table A2.1 Part III: Cleaning with other chemical solutions. A solution of 1% citric acid and 1% sodium nitrate may be applied at about 70° F. for about 60 minutes. Alternatively, a solution of about 5% to about 10% ammonium citrate may be applied at a temperature ranging from about 120° F. to about 1.60° F. for about 10 minutes to about 60 minutes. In another embodiment, an inhibited ammonia-neutralized solution of ethylenediaminetetraacetic acid (EDTA) at a temperature of up to about 250° F. at a temperature of about 6 hours followed by hot water rinse.

In at least one example embodiment, following any of the acid washes, the surface of the post should be rinsed until the rinse water has a ranging from about 6 to about 8.

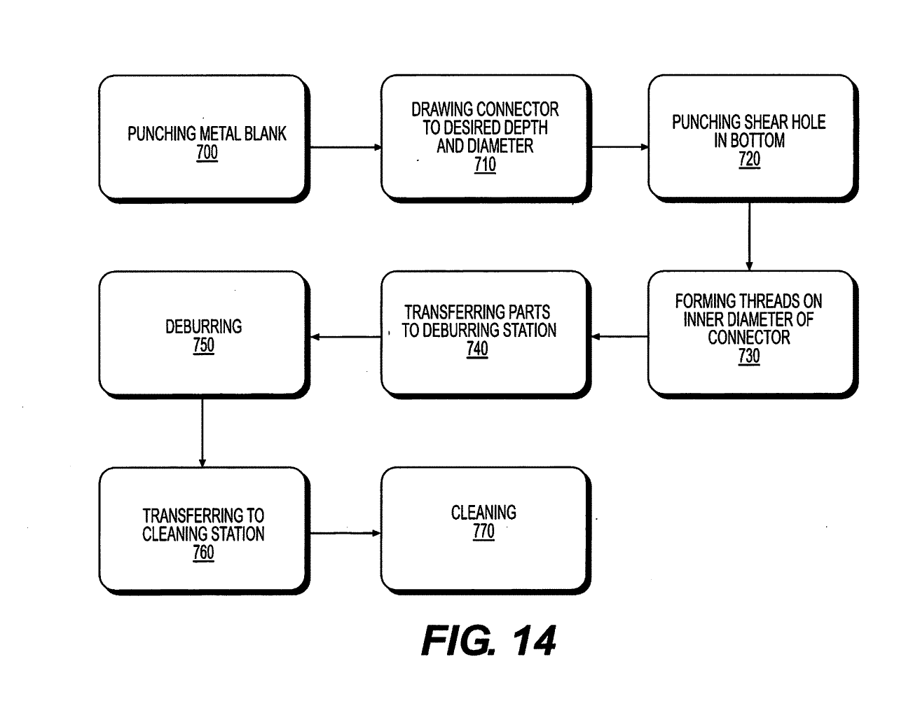

FIG. 14 is a flow chart illustrating a method of making a connector body according to at least one example embodiment.

At least one example embodiment relates to a method of forming a connector body of a cartridge of an electronic vaping device.

In at least one example embodiment, the method includes punching 700 a metal blank from a sheet of metal. The method may also include drawing 710 the blank to a desired depth and/or diameter using a series of punches and dies. The method may also include punching 720 a hole in a bottom portion of the drawn blank. The method may further include forming 730 a threaded portion on an inner diameter of the drawn blank. Once the threads are formed, the method may include transferring parts to a deburring station 740, deburring 750 the parts to remove sharp edges, transferring the parts to a cleaning station 760, and cleaning 770 the parts. The cleaning 770 of the connector body may be the same as the cleaning 560 of the post as set forth above. In addition, the connector body may be passivated if desired.

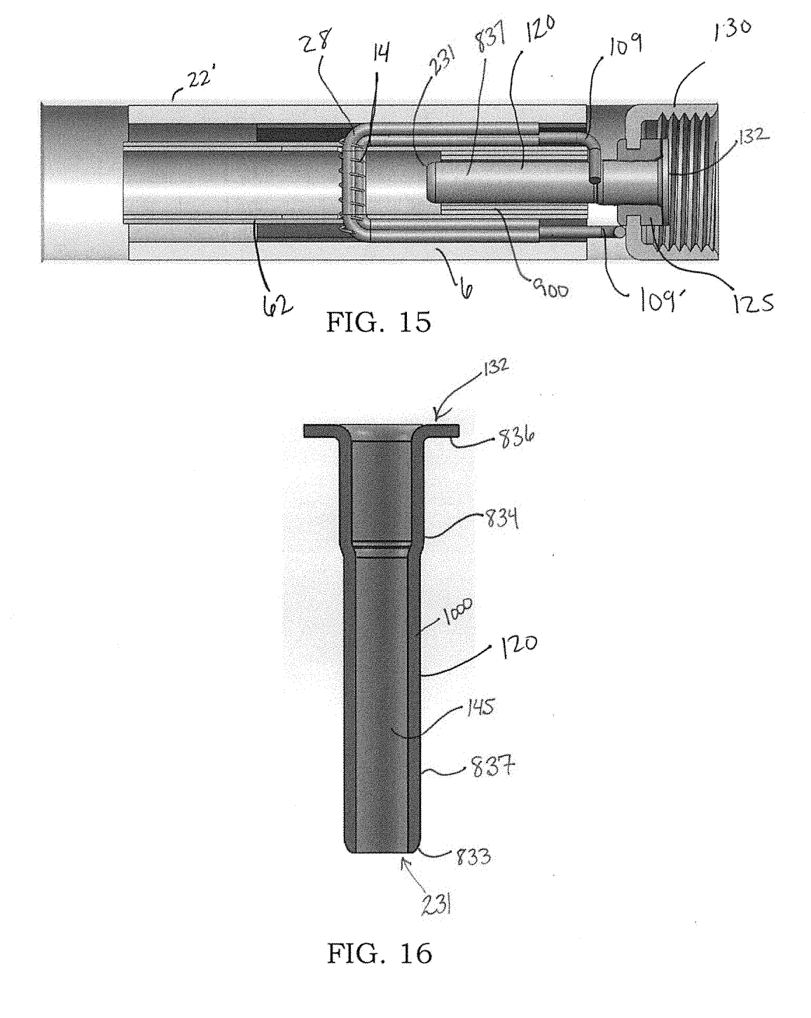

FIG. 15 is a cross-sectional view along line II-II of FIG. 1 of a first section according to at least one example embodiment.

In at least one example embodiment, as shown in FIG. 15, the first section 70 may be generally the same as in FIG. 2, but the post 120 may have a different configuration. As shown in FIG. 15, the post 120 has a nose portion 837 that is inserted into a portion of the inner tube 62.

In at least one example embodiment, spacer material 900 may be positioned between the nose portion 837 and the inner tube 62 if desired to ensure a friction fit and/or snug fit between the nose portion 837 and the inner tube 62. The spacer material 900 may be a fiberglass material, which may be the same or different than a material used to form the inner tube 62. The spacer material 900 may extend fully or partially along a length of the nose 837 of the post 120 inserted in the inner tube 62. The spacer material 900 may include one or more sheets of material. The spacer material 900 may be wrapped around the nose portion 837 of the post 120 before insertion in the inner tube 62.

In another example embodiment, the spacer material 900 may be adhered to an inner wall of the inner tube 62 prior to insertion of the nose portion 837 of the post 120.

In other example embodiments, the nose portion 837 may have an outer diameter that is about the same or less than an inner diameter of the inner tube 62 so as to ensure a snug fit without the use of the spacer material 900.

FIG. 16 is a cross-sectional view of the post of FIG. 15 according to at least one example embodiment.

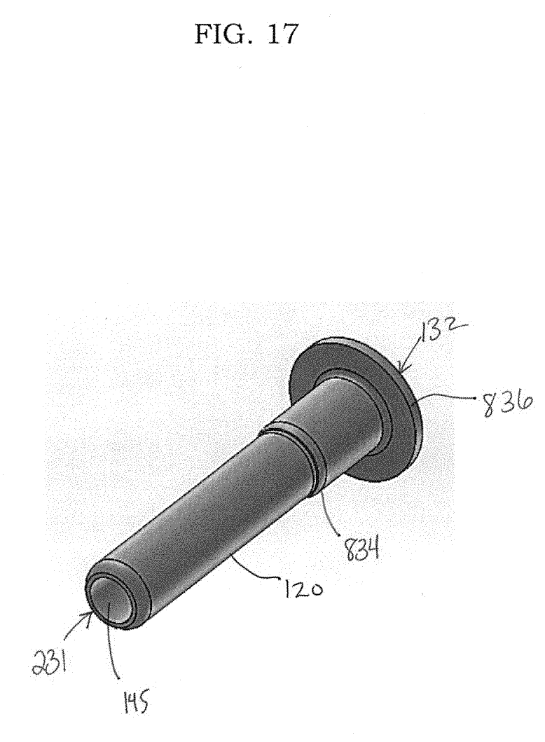

FIG. 17 is a perspective view of the post of FIG. 15 according to at least one example embodiment.

In at least one example embodiment, as shown in FIGS. 16 and 17, the post 120 may have a first end 231 and a second end 132. An edge at the first end 231 may be beveled or rounded to facilitate insertion in the inner tube 62 and/or spacer material 900.

An enlarged portion 834 is formed between the first end 231 and the second end 132. A flange 836 may be formed at the second end 132 of the post 120. The flange 836 may be sized and configured to abut the connector gasket 125 so as to maintain the position of the post 120 through the gasket and within the connector body 130.

In at least one example embodiment, the nose portion 837 is generally straight and has a length ranging from about 8 mm to about 10 mm. For example, the nose portion 837 may be about 9 mm in length. The enlarged portion 834 may have a length ranging from about 2.0 mm to about 4.0 mm, or about 3.0 mm.

In at least one example embodiment, an inner surface of the post 120 defines a flow passage 145. The flow passage 145 within the nose portion 837 may have an inner diameter ranging from about 1.40 mm to about 4.0 mm or about 1.6 mm to about 1.7 mm. An inner diameter of the enlarged portion 834 may range from about 1.50 mm to about 2.00 mm (about 1.80 mm to about 1.90 mm). The flange 836 has an outer diameter ranging from about 4.0 mm to about 6.0 mm, or about 4.8 mm to about 5.2 mm, A total length of the post 120 may range from about 10 mm to about 15 mm or about 12 mm to about 14 mm. The total length of the post may vary depending on the position of the inner tube 62 within the housing 22′.

In at least one example embodiment, the post 120 is formed of stainless steel and is formed by a deep drawn process. The post 120 may be cleaned, deburred, and subjected to a passivation process as described herein. The post 120 does not include sharp edges and is substantially free of burs.

A thickness of a wall 1000 of the post 120 may range from about 0.25 mm to about 0.50 mm. For example, the post 120 may have a wall 1000 thickness of about 0.38 mm.

While a number of example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

We claim:

1. A method of forming a post of a cartridge of an electronic vaping device, the method comprising:
cutting a blank from a sheet of metal;
drawing the blank to a desired diameter and length to form an elongate body;
drawing a portion of the elongate body to form a first end having an opening therein, the first end being generally cylindrical and having an edge;
forming a first portion between the first end and a second end of the elongate body; and
forming a second portion at the second end.

2. The method of claim 1, further comprising:
trimming a portion of the second portion to form the post.

3. The method of claim 2, further comprising:
debarring the post.

4. The method of claim 3, further comprising:
cleaning the post.

5. The method of claim 4, further comprising:
passivating the post.

6. The method of claim 5, wherein the passivating comprises:
treating the post with at least one of nitric acid and citric acid.

7. The method of claim 6, wherein the treating includes placing the post in a solution containing at least one of nitric acid and citric acid for about 1 minute to about 60 minutes at a temperature ranging from about 50° F. to about 200° F.

8. The method of claim 7, further comprising:
removing the post from the solution; and
rinsing the post with water until the water has a pH of about 6 to about 8.

9. The method of claim 1, wherein the blank is formed of stainless steel.

10. The method of claim 1, wherein the blank has a diameter ranging from about 0.500 inch to about 0.700 inch and a thickness ranging from about 0.010 inch to about 0.040 inch.

11. A method of forming a connector piece of a cartridge of an electronic vaping device, the method comprising:
forming a metal blank from a sheet of metal;
drawing the metal blank to a desired depth and diameter to form a connector piece body;
punching a hole in a first end of the connector piece body; and
forming a threaded portion on an inner surface of a second end of the connector piece body to form the connector piece.

12. The method of claim 11, further comprising:
deburring the connector piece.

13. The method of claim 12, further comprising:
cleaning the connector piece.

14. The method of claim 11, wherein the forming a threaded portion comprises:
using a tap to form the threaded portion.

15. The method of claim 11, wherein the forming a threaded portion comprises:
thread rolling to form the threaded portion.

16. The method of claim 11, wherein the blank has a diameter ranging from about 0.750 inch to about 1.000 inch and a thickness ranging from about 0.010 inch to about 0.060 inch.

17. A cartridge of an electronic vaping device comprising:
an outer housing extending in a longitudinal direction, the outer housing having a first end and a second end;
an inner tube extending in the longitudinal direction, the inner tube within the outer housing;
a reservoir between the outer housing and the inner tube;
a heating element in the inner tube;
a first connector body in the second end of the outer housing, the first connector body being generally cylindrical, the first connector body including,
an orifice extending through the first connector body, the orifice extending in the longitudinal direction;
a connector gasket extending through a portion of the orifice in the first connector body, the connector gasket including a second orifice extending in the longitudinal direction through the connector gasket; and
a post extending through the second orifice in the connector gasket, the post including,
a first post end, and
a second post end, the first post end sized and configured to fit within the inner tube, the first post end in direct contact with an inner wall of the inner tube, the second post end in contact with a portion of the first connector body, and the cartridge excluding a gasket in contact with the reservoir.

18. The cartridge of claim 17, wherein the heating element includes opposing end portions extending into the reservoir.

19. The cartridge of claim 18, further comprising:
a first electrical lead and a second electrical lead, the first and second electrical leads connected to respective ones of the opposing end portions of the heating element.

20. The cartridge of claim 19, wherein the first electrical lead is attached to the first connector body and the second electrical lead is attached to the post.

21. The cartridge of claim 17, wherein the post includes an air flow passage extending therethrough, the air flow passage establishing an air flow channel between the connector and the inner tube.

22. The cartridge of claim 21, wherein the air flow passage has an inner diameter ranging from about 1.50 mm to about 1.70 mm.

23. The cartridge of claim 21, wherein the post includes a first portion between a first end and a second end thereof, the first portion sized and configured to maintain the post within the second orifice of the connector gasket.

24. The cartridge of claim 23, wherein the post includes a second portion at the second end thereof, the second portion configured to contact an inner surface of the first connector body.

25. The cartridge of claim 24, wherein the first end of the post has about a same diameter as an outer diameter of the second portion of the post.

26. The cartridge of claim 17, wherein the first connector body and the post are formed of stainless steel.

27. The cartridge of claim 1 therein an outer diameter of the first post end is about the same as an inner diameter of the inner tube.

28. The cartridge of claim 17, wherein the first end of the post has a larger diameter than a central portion of the post.

29. The cartridge of claim 17, therein the first end of the post is generally cylindrical.

30. The cartridge of claim 29, wherein the first end of the post includes a beveled edge.
